(19) United States
(12) Patent Application Publication
(10) Pub. No.: US 2022/0270023 A1
(43) Pub. Date: Aug. 25, 2022

(54) INFORMATION PROCESSING DEVICE, NON-TRANSITORY STORAGE MEDIUM, AND INFORMATION PROCESSING METHOD

(71) Applicant: TOYOTA JIDOSHA KABUSHIKI KAISHA, Aichi-ken (JP)

(72) Inventors: Satoshi KOMAMINE, Nagoya-shi (JP); Toyokazu NAKASHIMA, Nagoya-shi (JP); Koichi SUZUKI, Miyoshi-shi (JP); Lei WANG, Toyota-shi (JP); Jun KARASHIMA, Toyota-shi (JP); Kenichi YAMADA, Nisshin-shi (JP); Hiromitsu FUJII, Kariya-shi (JP); Shota MINAMI, Nagoya-shi (JP)

(21) Appl. No.: 17/672,618

(22) Filed: Feb. 15, 2022

(30) Foreign Application Priority Data
Feb. 19, 2021 (JP) 2021-025692

(51) Int. Cl. G06Q 10/06; H04W 4/029; G06Q 30/00

(52) U.S. Cl. CPC G06Q 10/063114; H04W 4/029; G06Q 30/01

(57) ABSTRACT

An information processing device includes a control unit configured to: acquire information about a service that can be provided by a service provider; acquire information about a need for a service desired to be received by a service receiver; acquire information about travel expected to be made by the service provider; extract a need that can be handled by the service provider providing the service during the travel, among needs that can be handled by the service; and transmit information about the extracted need to a terminal device of the service provider.

### CROSS-REFERENCE TO RELATED APPLICATION

This application claims priority to Japanese Patent Application No. 2021-025692 filed on Feb. 19, 2021, incorporated herein by reference in its entirety.

### BACKGROUND

### 1. Technical Field

The present disclosure relates to an information processing device, a non-transitory storage medium, and an information processing method.

### 2. Description of Related Art

There is known a technique that connects between a service provider that can provide a service and a service receiver that desires to receive the service.

Japanese Unexamined Patent Application Publication No. 2001-338067 (JP 2001-338067 A), for example, discloses a technique that matches a caretaker who provides a service and a person to be taken care of who receives the service, and coordinating their schedules and a service providing location.

### SUMMARY

There is room for improvement in the technique that connects between a service provider and a service receiver.

An object of the present disclosure is to improve a technique that connects between a service provider and a service receiver.

The present disclosure relates to an information processing device including a control unit configured to: acquire information about a service to be possibly provided by a service provider; acquire information about a need for a service desired to be received by a service receiver; acquire information about travel expected to be made by the service provider; extract a need to be possibly handled by the service provider providing the service during the travel, among needs to be possibly handled by the service; and transmit information about the extracted need to a terminal device of the service provider.

The present disclosure relates to a non-transitory storage medium storing instructions that are executable by one or more processors and that cause the one or more processors to perform functions including: acquiring information about a service to be possibly provided by a service provider; acquiring information about a need for a service desired to be received by a service receiver; acquiring information about travel expected to be made by the service provider; extracting a need to be possibly handled by the service provider providing the service during the travel, among needs to be possibly handled by the service; and transmitting information about the extracted need to a terminal device of the service provider.

The present disclosure relates to an information processing method performed by an information processing device. The information processing method includes: acquiring information about a service to be possibly provided by a service provider; acquiring information about a need for a service desired to be received by a service receiver; acquiring information about travel expected to be made by the service provider; extracting a need to be possibly handled by the service provider providing the service during the travel, among needs to be possibly handled by the service; and transmitting information about the extracted need to a terminal device of the service provider.

With the present disclosure, it is possible to improve a technique that connects between a service provider and a service receiver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates the configuration of an information processing system according to an embodiment of the present disclosure;

FIG. 2 is a block diagram illustrating the configuration of an information processing device according to the embodiment of the present disclosure;

FIG. 3 is a block diagram illustrating the configuration of a first terminal device according to the embodiment of the present disclosure;

FIG. 4 is a block diagram illustrating the configuration of a second terminal device according to the embodiment of the present disclosure; and

FIG. 5 is a flowchart illustrating operation of the information processing system according to the embodiment of the present disclosure.

### DETAILED DESCRIPTION OF EMBODIMENTS

An embodiment of the present disclosure will be described below with reference to the drawings.

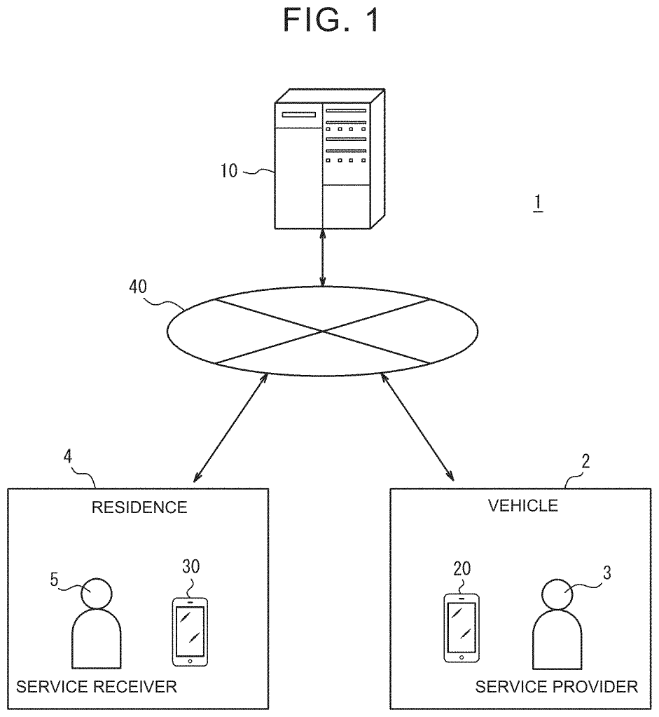

FIG. 1 illustrates the configuration of an information processing system 1 according to an embodiment of the present disclosure. The configuration and an overview of the information processing system 1 according to the embodiment of the present disclosure will be described with reference to FIG. 1.

The information processing system 1 includes an information processing device 10, a first terminal device 20, and a second terminal device 30. The information processing device 10, the first terminal device 20, and the second terminal device 30 are communicably connected to each other via a network 40. The network 40 may be a network including a mobile communication network, the Internet, etc.

While FIG. 1 illustrates one information processing device 10, one first terminal device 20, and one second terminal device 30, there may be two or more information processing devices 10, two or more first terminal devices 20, and two or more second terminal devices 30.

The first terminal device 20 is a terminal device owned by a service provider 3 who is expected to travel on a vehicle 2. While FIG. 1 illustrates a state in which the service provider 3 is on the vehicle 2, the service provider 3 may not be on the vehicle 2.

The vehicle 2 may be an automobile of any type such as a gasoline vehicle, a diesel vehicle, a hybrid vehicle (HV), a plug-in hybrid vehicle (PHV), an electric vehicle (EV), and a fuel cell vehicle (FCV), for example. While the vehicle 2 is driven by the service provider 3 in the present embodiment, driving of the vehicle 2 may be automated to a desired level. The level of automation may be any of Level 1 to Level 5 defined by the Society of Automotive Engineers (SAE), for example. The vehicle 2 may be a vehicle dedicated to Mobility as a Service (MaaS).

The service provider 3 is a person who can provide a certain service. The service provider 3 may be capable of providing a service such as shopping on someone's behalf, cleaning, cooking, physical work, and volunteering, for example. The service provider 3 registers information about the service that can be provided by the service provider 3 in the information processing device 10. The service provider 3 can provide the service to the service receiver 5 by visiting a residence 4 of the service receiver 5 in the course of traveling to a destination on the vehicle 2.

The second terminal device 30 is a terminal device owned by the service receiver 5 who resides in the residence 4. While FIG. 1 illustrates a state in which the service receiver 5 is in the residence 4, the service receiver 5 may not be in the residence 4.

The service receiver 5 is a person who desires to receive a certain service. The service receiver 5 may desire to receive a service such as shopping on his/her behalf, cleaning, cooking, physical work, and volunteering, for example. The service receiver 5 registers information about the need for a service desired to be received in the information processing device 10. The service receiver 5 can receive the service from the service provider 3 who is in the course of traveling to a destination on the vehicle 2.

The information processing device 10 is a dedicated computer configured to function as a server, for example. The information processing device 10 may be a general-purpose personal computer (PC).

The information processing device 10 can communicate with the first terminal device 20 and the second terminal device 30 via the network 40. The information processing device 10 acquires information about the service that can be provided by the service provider 3 from the first terminal device 20. The information processing device 10 acquires information about the need for the service desired to be received by the service receiver 5 from the second terminal device 30. The information processing device 10 extracts a need that can be handled by the service provider 3 while traveling on the vehicle 2, among the needs of the service receiver 5 that can be handled by the service that can be provided by the service provider 3. The information processing device 10 transmits information about the extracted need to the first terminal device 20 of the service provider 3.

The first terminal device 20 can communicate with the information processing device 10 via the network 40. The first terminal device 20 is a terminal device owned by the service provider 3. The first terminal device 20 may be a smartphone or a tablet, for example.

The second terminal device 30 can communicate with the information processing device 10 via the network 40. The second terminal device 30 is a terminal device owned by the service receiver 5. The second terminal device 30 may be a smartphone or a tablet, for example.

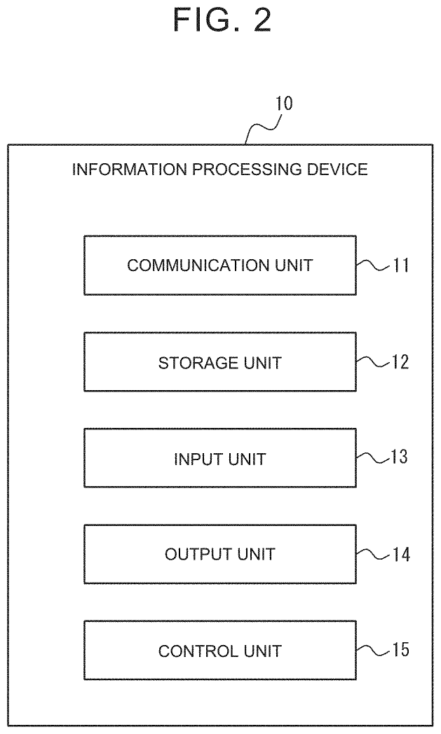

The configuration of the information processing device 10 according to the embodiment of the present disclosure will be described with reference to FIG. 2.

The information processing device 10 includes a communication unit 11, a storage unit 12, an input unit 13, an output unit 14, and a control unit 15.

The communication unit 11 includes a communication module connected to the network 40. For example, the communication unit 11 may include a communication module that supports a local area network (LAN). In one embodiment, the information processing device 10 is connected to the network 40 via the communication unit 11. The communication unit 11 transmits and receives various types of information via the network 40. The communication unit 11 can communicate with the first terminal device 20 and the second terminal device 30 via the network 40.

Examples of the storage unit 12 include, but are not limited to, a semiconductor memory, a magnetic memory, an optical memory, etc. The storage unit 12 may function as a main storage device, an auxiliary storage device, or a cache memory, for example. The storage unit 12 stores any information that is used for operation of the information processing device 10. For example, the storage unit 12 may store a system program, an application program, various types of information received by the communication unit 11, etc. The information stored in the storage unit 12 may be updated using information received from the network 40 via the communication unit 11, for example. A part of the storage unit 12 may be installed outside the information processing device 10. In that case, the part of the storage unit 12 installed outside may be connected to the information processing device 10 via a desired interface.

The input unit 13 includes one or more input interfaces for acquiring input information based on an operation by a user. Examples of the input unit 13 include, but are not limited to, a physical key, a capacitance key, a touch screen provided integrally with a display of the output unit 14, a microphone that receives an audio input, etc.

The output unit 14 includes one or more output interfaces that notify the user by outputting information. Examples of the output unit 14 include, but are not limited to, a display that outputs information as an image, a speaker that outputs information as audio, etc.

The control unit 15 includes at least one processor, at least one dedicated circuit, or a combination of these. The processor may be a general-purpose processor such as a central processing unit (CPU) or a graphics processing unit (GPU), or a dedicated processor specifically for a specific process. Examples of the dedicated circuit include a field-programmable gate array (FPGA) and an application-specific integrated circuit (ASIC). The control unit 15 executes a process related to operation of the information processing device 10 while controlling the various units of the information processing device 10.

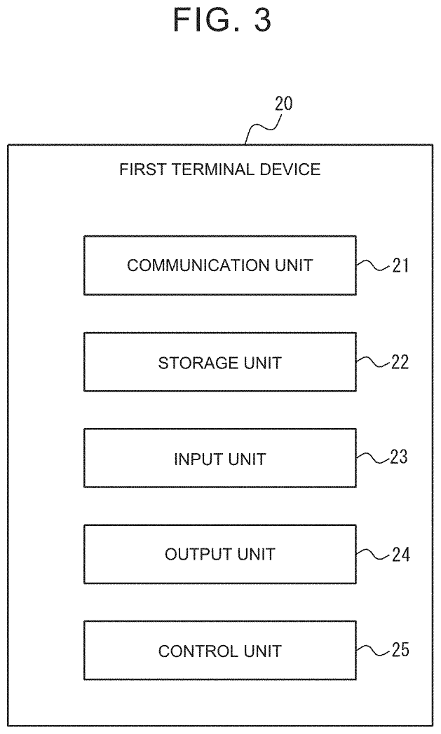

The configuration of the first terminal device 20 according to the embodiment of the present disclosure will be described with reference to FIG. 3.

The first terminal device 20 includes a communication unit 21, a storage unit 22, an input unit 23, an output unit 24, and a control unit 25.

The communication unit 21 includes a communication module connected to the network 40. For example, the communication unit 21 may include a communication module that supports mobile communication standards such as LTE, 4G, and 5G. In one embodiment, the first terminal device 20 is connected to the network 40 via the communication unit 21. The communication unit 21 transmits and receives various types of information via the network 40. The communication unit 21 can communicate with the information processing device 10 via the network 40.

Examples of the storage unit 22 include, but are not limited to, a semiconductor memory, a magnetic memory, an optical memory, etc. The storage unit 22 may function as a main storage device, an auxiliary storage device, or a cache memory, for example. The storage unit 22 stores any information that is used for operation of the first terminal device 20. For example, the storage unit 22 may store a system program, an application program, various types of information received by the communication unit 21, etc. The information stored in the storage unit 22 may be updated using information received from the network 40 via the communication unit 21, for example. A part of the storage unit 22 may be installed outside the first terminal device 20. In that case, the part of the storage unit 22 installed outside may be connected to the first terminal device 20 via a desired interface.

The input unit 23 includes one or more input interfaces for acquiring input information based on an operation by a user. Examples of the input unit 23 include, but are not limited to, a physical key, a capacitance key, a touch screen provided integrally with a display of the output unit 24, a microphone that receives an audio input, etc.

The output unit 24 includes one or more output interfaces that notify the user by outputting information. Examples of the output unit 24 include, but are not limited to, a display that outputs information as an image, a speaker that outputs information as audio, etc.

The control unit 25 includes at least one processor, at least one dedicated circuit, or a combination of these. The processor may be a general-purpose processor such as a CPU or a GPU, or a dedicated processor specifically for a specific process. Examples of the dedicated circuit include an FPGA and an ASIC. The control unit 25 executes a process related to operation of the first terminal device 20 while controlling the various units of the first terminal device 20.

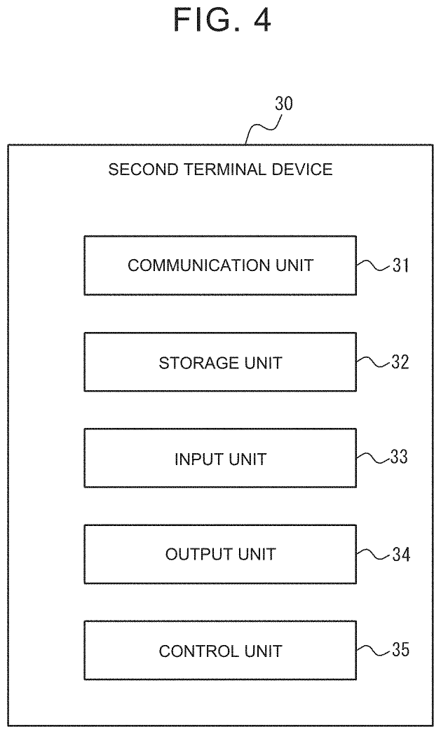

The configuration of the second terminal device 30 according to the embodiment of the present disclosure will be described with reference to FIG. 4.

The second terminal device 30 includes a communication unit 31, a storage unit 32, an input unit 33, an output unit 34, and a control unit 35.

The communication unit 31 includes a communication module connected to the network 40. For example, the communication unit 31 may include a communication module that supports mobile communication standards such as LTE, 4G, and 5G. In one embodiment, the second terminal device 30 is connected to the network 40 via the communication unit 31. The communication unit 31 transmits and receives various types of information via the network 40. The communication unit 31 can communicate with the information processing device 10 via the network 40.

Examples of the storage unit 32 include, but are not limited to, a semiconductor memory, a magnetic memory, an optical memory, etc. The storage unit 32 may function as a main storage device, an auxiliary storage device, or a cache memory, for example. The storage unit 32 stores any information that is used for operation of the second terminal device 30. For example, the storage unit 32 may store a system program, an application program, various types of information received by the communication unit 31, etc. The information stored in the storage unit 32 may be updated using information received from the network 40 via the communication unit 31, for example. A part of the storage unit 32 may be installed outside the second terminal device 30. In that case, the part of the storage unit 32 installed outside may be connected to the second terminal device 30 via a desired interface.

The input unit 33 includes one or more input interfaces for acquiring input information based on an operation by a user. Examples of the input unit 33 include, but are not limited to, a physical key, a capacitance key, a touch screen provided integrally with a display of the output unit 34, a microphone that receives an audio input, etc.

The output unit 34 includes one or more output interfaces that notify the user by outputting information. Examples of the output unit 34 include, but are not limited to, a display that outputs information as an image, a speaker that outputs information as audio, etc.

The control unit 35 includes at least one processor, at least one dedicated circuit, or a combination of these. The processor may be a general-purpose processor such as a CPU or a GPU, or a dedicated processor specifically for a specific process. Examples of the dedicated circuit include an FPGA and an ASIC. The control unit 35 executes a process related to operation of the second terminal device 30 while controlling the various units of the second terminal device 30.

### Operation of Information Processing System

Operation of the information processing system 1 illustrated in FIG. 1 will be described with reference to FIGS. 1 to 4.

The service provider 3 inputs information about the service that can be provided to the input unit 23 of the first terminal device 20. The information about the service that can be provided by the service provider 3 may include information on the type of the service, the time taken to provide the service, the fee for the service, etc., for example. The service provider 3 can input the information about the service that can be provided to the input unit 23 of the first terminal device 20 at a desired timing.

The control unit 25 transmits the information about the service that can be provided by the service provider 3, which has been received by the input unit 23, to the information processing device 10 via the communication unit 21.

The communication unit 11 of the information processing device 10 receives the information about the service that can be provided by the service provider 3, which has been transmitted by the first terminal device 20. The control unit 15 acquires the information about the service that can be provided by the service provider 3, which has been transmitted by the first terminal device 20, via the communication unit 11. The control unit 15 stores the information about the service that can be provided by the service provider 3 in the storage unit 12.

The service provider 3 can register the information about the service that can be provided in the information processing device 10 through the processes discussed above. The service provider 3 can register information about at least one or more services in the information processing device 10. There may be any number of service providers 3, the number being one or more. When there are a plurality of service providers 3, each of the service providers 3 can register the information about the service that can be provided in the information processing device 10.

The service receiver 5 inputs information about the need for a service desired to be received to the input unit 33 of the second terminal device 30. The information about the need for the service desired to be received by the service receiver 5 may include information on the type of the service desired to be received, the time when the service is desired to be received, the fee that can be paid for the service, etc., for example. The service receiver 5 can input the information about the need for the service desired to be received to the input unit 33 of the second terminal device 30 at a desired timing.

The control unit 35 transmits the information about the need for the service desired to be received by the service receiver 5, which has been received by the input unit 33, to the information processing device 10 via the communication unit 31.

The communication unit 11 of the information processing device 10 receives the information about the need for the service desired to be received by the service receiver 5, which has been transmitted by the second terminal device 30. The control unit 15 acquires the information about the need for the service desired to be received by the service receiver 5, which has been transmitted by the second terminal device 30, via the communication unit 11. The control unit 15 stores the information about the need for the service desired to be received by the service receiver 5 in the storage unit 12.

The service receiver 5 can register the information about the need for the service desired to be received in the information processing device 10 through the processes discussed above. The service receiver 5 can register information about the need for at least one or more services in the information processing device 10. There may be any number of service receivers 5, the number being one or more. When there are a plurality of service receivers 5, each of the service receivers 5 can register information about the need for the service desired to be received in the information processing device 10.

The control unit 25 of the first terminal device 20 transmits the information about the travel expected to be made by the service provider 3 to the information processing device 10 via the communication unit 21. The control unit 25 may extract information about the travel expected to be made by the service provider 3 based on schedule information on the service provider 3 stored in the storage unit 22 by the service provider 3, and transmit the information about the travel expected to be made by the service provider 3 to the information processing device 10.

The control unit 25 may transmit the information about the travel expected to be made by the service provider 3 to the information processing device 10 a predetermined time before the time of departure for the travel expected to be made by the service provider 3. The predetermined time may be a desired time set in advance. When the predetermined time is three days, for example, the control unit 25 transmits the information about the travel expected to be made by the service provider 3 to the information processing device 10 three days before the time of departure for the travel expected to be made by the service provider 3.

The information about the travel expected to be made by the service provider 3 may be information including at least one of the route of the travel, the departure location of the travel, the destination of the travel, the expected departure time, the expected arrival time, the time when the destination has to be reached, the expected time of passage through each location, etc., for example.

The communication unit 11 of the information processing device 10 receives the information about the travel expected to be made by the service provider 3, which has been transmitted by the first terminal device 20. The control unit 15 acquires the information about the travel expected to be made by the service provider 3, which has been transmitted by the first terminal device 20, via the communication unit 11. The control unit 15 stores the information about the travel expected to be made by the service provider 3 in the storage unit 12.

When the information about the travel expected to be made by the service provider 3 is acquired, the control unit 15 extracts a need that can be handled by the service provider 3 providing a service during travel, among the needs that can be handled by the service that can be provided by the service provider 3 who expects to travel. The control unit 15 may extract a need that can be handled by the service provider 3 providing a service during travel, by referencing the needs of the service receiver 5 stored in advance in the storage unit 12.

The control unit 15 may extract a need that can be handled by the service provider 3 providing a service during travel through two-step extraction processes, for example.

The control unit 15 may compare the information about the service that can be provided by the service provider 3 to the information about the need for the service desired to be received by the service receiver 5, and extract a need that can be handled by the service that can be provided by the service provider 3, in the initial extraction process.

When the type of the service included in the information about the service that can be provided by the service provider 3 and the type of the service desired to be received included in the information about the need for the service desired to be received by the service receiver 5 coincide with each other, for example, the control unit 15 may determine that the need can be handled by the service that can be provided by the service provider 3, and extract the need.

When at least one or more needs are extracted through the initial extraction process, the control unit 15 may extract a need that can be handled by the service provider 3 during travel, from among the needs.

The control unit 15 may extract a need for a service that can be provided by the service provider 3 visiting the service receiver 5 before arriving at the destination of the expected travel, as the need that can be handled by the service provider 3 during travel, for example.

The control unit 15 may extract a need for a service that can be provided by the service provider 3 visiting the service receiver 5 in the course of the expected travel without hindering the service provider 3 from arriving at the destination of the expected travel by the time when the destination has to be reached, as the need that can be handled by the service provider 3 during travel, for example.

The control unit 15 may extract a need that can be handled by the service provider 3 during travel based on the time taken by the service provider 3 to provide a service corresponding to the need of the service receiver 5, for example.

The control unit 15 may extract a need that increases the travel time by a predetermined time or less when a service corresponding to the need of the service receiver 5 is provided by visiting the residence 4 of the service receiver 5 in the course of travel, as the need that can be handled by the service provider 3 during travel, for example.

When there are a plurality of needs that can be handled by the service provider 3 during travel, the control unit 15 may extract a need that increases the travel time to the smallest degree when a corresponding service is provided.

When a need that can be handled by the service provider 3 during travel is extracted, the control unit 15 transmits information about the extracted need to the first terminal device 20 via the communication unit 11.

The communication unit 21 of the first terminal device 20 receives information about the need that can be handled by the service provider 3 during travel, which has been transmitted by the information processing device 10. The control unit 25 acquires the information about the need that can be handled by the service provider 3 during travel, which has been transmitted by the information processing device 10, via the communication unit 21. The control unit 25 causes the output unit 24 to output the information about the need that can be handled by the service provider 3 during travel. Consequently, the service provider 3 can check the information about the need that can be handled by the service provider 3 during the expected travel. In order to handle the need that has been checked, the service provider 3 can provide a service by visiting the residence 4 of the service receiver 5 in the course of traveling on the vehicle 2, and thereafter travel to the destination, for example. The service receiver 5 can receive a service corresponding to the need of the service receiver 5 from the service provider 3 in the course of travel.

When a need that can be handled by the service provider 3 during travel is extracted, the control unit 15 may calculate an expected time of arrival at the travel destination for a case where the service provider 3 visits the service receiver 5 in order to provide a service corresponding to the need in the course of the travel. The control unit 15 may transmit the calculated expected arrival time to the first terminal device 20 via the communication unit 11.

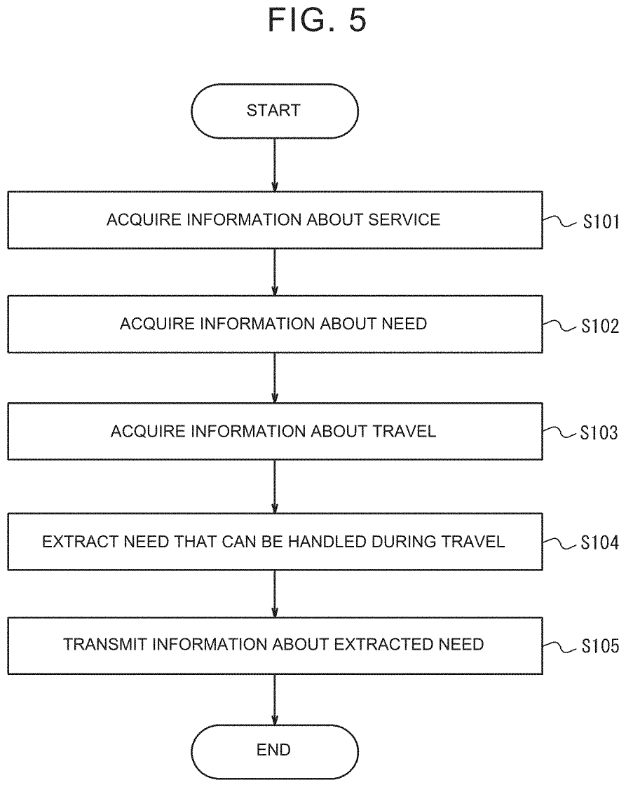

Operation of the information processing system 1 will be described with reference to the flowchart illustrated in FIG. 5.

In step S101, the control unit 15 of the information processing device 10 acquires information about a service that can be provided by the service provider 3.

In step S102, the control unit 15 acquires information about the need for a service desired to be received by the service receiver 5.

Step S101 and step S102 may be executed at desired timings. That is, step S102 may be executed before step S101, or step S101 and step S102 may be executed at the same time.

In step S103, the control unit 15 acquires information about travel expected to be made by the service provider 3. For example, the control unit 15 acquires information about travel expected to be made by the service provider 3 a predetermined time before the time of departure for the travel expected to be made by the service provider 3, for example.

In step S104, the control unit 15 extracts a need that can be handled by the service provider 3 providing a service during travel, among the needs that can be handled by the service that can be provided by the service provider 3 who expects to travel.

In step S105, the control unit 15 transmits information about the need extracted in step S104 to the first terminal device 20 of the service provider 3.

In the information processing device 10 according to the present embodiment, as discussed above, the control unit 15 acquires information about a service that can be provided by the service provider 3, acquires information about the need for a service desired to be received by the service receiver 5, acquires information about travel expected to be made by the service provider 3, extracts a need that can be handled by the service provider 3 providing a service during travel, among the needs that can be handled by the service that can be provided by the service provider 3, and transmits information about the extracted need to the first terminal device 20 of the service provider 3. Consequently, the service provider 3 who has checked the information about the extracted need can provide a service to the service receiver 5 by visiting the service receiver 5 in the course of the expected travel. Thus, the information processing device 10 according to the present embodiment can improve the technique of connecting the service provider 3 and the service receiver 5.

The present disclosure is not limited to the embodiment discussed above. For example, a plurality of blocks illustrated in the block diagram may be integrated with each other, or a single block may be divided into pieces. A plurality of steps indicated in the flowchart may be executed in parallel, or in a different order, in accordance with the processing capability of the device that executes the steps, or as necessary, rather than being executed chronologically in accordance with the description. Other modifications can be made without departing from the spirit and scope of the present disclosure.

For example, a part of the processing operation executed by the information processing device 10 in the embodiment discussed above may be executed by the first terminal device 20 or the second terminal device 30. A part of the processing operation executed by the first terminal device 20 in the embodiment discussed above may be executed by the information processing device 10. A part of the processing operation executed by the second terminal device 30 in the embodiment discussed above may be executed by the information processing device 10.

A general-purpose electronic device such as a smartphone or a computer may be configured to function as the information processing device 10 according to the embodiment discussed above, for example. Specifically, a program that describes the content of processes that implement the functions of the information processing device 10 etc. according to the embodiment is stored in a memory of the electronic device, and the program is read and executed by a processor of the electronic device. Thus, the disclosure according to one embodiment can be implemented also as a program that can be executed by a processor.

While the service provider 3 travels on the vehicle 2 in the embodiment discussed above, the service provider 3 may travel by a mode of transportation other than the vehicle 2, for example. For example, the service provider 3 may travel using public transportation.

While the service receiver 5 is in the residence 4 in the embodiment discussed above, the service receiver 5 may not be in the residence 4 when the service receiver 5 receives a provided service, for example.

What is claimed is:

1. An information processing device comprising a control unit configured to:
acquire information about a service to be possibly provided by a service provider;
acquire information about a need for a service desired to be received by a service receiver;
acquire information about travel expected to be made by the service provider;
extract a need to be possibly handled by the service provider providing the service during the travel, among needs to be possibly handled by the service; and
transmit information about the extracted need to a terminal device of the service provider.

2. The information processing device according to claim 1, wherein the control unit acquires the information about the travel based on schedule information on the service provider.

3. The information processing device according to claim 1, wherein the control unit extracts, as the need to be possibly handled by the service provider during the travel, a need to be possibly handled by visiting the service receiver before arriving at a destination of the travel.

4. The information processing device according to claim 1, wherein the information about the travel includes information on a route of the travel, a departure location of the travel, and a destination of the travel.

5. The information processing device according to claim 1, wherein the control unit is configured to:
acquire, as the information about the travel, information on a time when a destination of the travel has to be reached; and
extract a need to be possibly handled by visiting the service receiver before arriving at a destination of the travel, based on whether the destination is possibly reached by the time.

6. The information processing device according to claim 1, wherein the control unit extracts a need to be possibly handled by visiting the service receiver before arriving at a destination of the travel, based on a time taken to provide the service.

7. The information processing device according to claim 1, wherein the control unit transmits, to the terminal device of the service provider, an expected time of arrival at a destination of the travel for a case where the service provider provides the service by visiting the service receiver.

8. A non-transitory storage medium storing instructions that are executable by one or more processors and that cause the one or more processors to perform functions comprising:
acquiring information about a service to be possibly provided by a service provider;
acquiring information about a need for a service desired to be received by a service receiver;
acquiring information about travel expected to be made by the service provider;
extracting a need to be possibly handled by the service provider providing the service during the travel, among needs to be possibly handled by the service; and
transmitting information about the extracted need to a terminal device of the service provider.

9. The non-transitory storage medium according to claim 8, wherein the functions further include acquiring the information about the travel based on schedule information on the service provider.

10. The non-transitory storage medium according to claim 8, wherein the functions further include extracting, as the need to be possibly handled by the service provider during the travel, a need to be possibly handled by visiting the service receiver before arriving at a destination of the travel.

11. The non-transitory storage medium according to claim 8, wherein the information about the travel includes information on a route of the travel, a departure location of the travel, and a destination of the travel.

12. The non-transitory storage medium according to claim 8, wherein the functions further include:
acquiring, as the information about the travel, information on a time when a destination of the travel has to be reached; and
extracting a need to be possibly handled by visiting the service receiver before arriving at the destination of the travel, based on whether the destination is possibly reached by the time.

13. The non-transitory storage medium according to claim 8, wherein the functions further include extracting a need to be possibly handled by visiting the service receiver before arriving at a destination of the travel, based on a time taken to provide the service.

14. The non-transitory storage medium according to claim 8, wherein the functions further include transmitting, to the terminal device of the service provider, an expected time of arrival at a destination of the travel for a case where the service provider provides the service by visiting the service receiver.

15. An information processing method performed by an information processing device, comprising:
acquiring information about a service to be possibly provided by a service provider;
acquiring information about a need for a service desired to be received by a service receiver;
acquiring information about travel expected to be made by the service provider;
extracting a need to be possibly handled by the service provider providing the service during the travel, among needs to be possibly handled by the service; and
transmitting information about the extracted need to a terminal device of the service provider.

16. The information processing method according to claim 15, further comprising acquiring the information about the travel based on schedule information on the service provider.

17. The information processing method according to claim 15, further comprising extracting, as the need to be possibly handled by the service provider during the travel, a need to be possibly handled by visiting the service receiver before arriving at a destination of the travel.

18. The information processing method according to claim 15, wherein the information about the travel includes information on a route of the travel, a departure location of the travel, and a destination of the travel.

19. The information processing method according to claim 15, further comprising:
acquiring, as the information about the travel, information on a time when a destination of the travel has to be reached; and
extracting a need to be possibly handled by visiting the service receiver before arriving at the destination of the travel, based on whether the destination is possibly reached by the time.

20. The information processing method according to claim 15, further comprising extracting a need to be possibly handled by visiting the service receiver before arriving at a destination of the travel, based on a time taken to provide the service.
